(19) United States
(12) Patent Application Publication
(10) Pub. No.: US 2022/0290578 A1
(43) Pub. Date: Sep. 15, 2022

(54) Turbine Motor for Use with a Pneumatic Tool

(71) Applicant: ATI Industrial Automation, Inc., Apex, NC (US)

(72) Inventors: David John Bohle, II, Cary, NC (US); Taylor Edwin Nichols, Raleigh, NC (US)

(21) Appl. No.: 17/199,872

(22) Filed: Mar. 12, 2021

(51) Int. Cl. F01D 21/00; F01D 25/24; F01D 15/06

(52) U.S. Cl. CPC F01D 21/006; F01D 25/24; F01D 15/06; F05D 2210/12; F05D 2260/90

(57) ABSTRACT

A turbine motor configured to be connected to a tool. The turbine motor includes a receptacle that houses a turbine blade. A channel is configured to receive air to drive the turbine blade. The turbine motor is configured to provide for one or more features that provide enhanced functionality. One feature includes a modular design that can be tailored to adjust the torque of the turbine blade and thus the output of the turbine motor. Another feature includes a brake that stops rotation of the turbine blade.

### FIELD OF INVENTION

The present invention relates generally to industrial tools, and in particular to turbine motors that can be used to power pneumatic tools.

### BACKGROUND

Pneumatic tools, sometimes referred to as air tools, are driven or powered by compressed air. These tools are often less heavy than electric tools and can be less prone to breaking down. There are many different types of pneumatic tools including but not limited to grinders, drills, and saws, and the tools have wide application in many different environments. In industrial applications, pneumatic tools are commonly deployed on robots, computerized numerical control (CNC) equipment, and the like, to perform routine and repetitive tasks. One such task is the deburring of the edges of machined or cast parts. In a typical deburring operation, a deburring tool is directed along a path around the edge of a part or object that is to be deburred.

An advantage of pneumatic tools is an abundant amount of compressed air, at required pressures, humidity, and the like, can be supplied reliably and inexpensively by basic equipment. Compressed air is not flammable or toxic, it carries no shock hazard, and it generates no waste products. However, there are currently a limited number of options for pneumatic tools, particularly pneumatic tools for high-speed material removal devices.

Pneumatic tools can include one or more internal components that are rotated at various speeds. For example, a deburring tool can include a bit that rotates at to cut the object. Different tools require different amounts of torque depending upon the specific aspects of the tool and/or the application for which they are being used. It can be advantageous for a tool design to be configurable to accommodate the needs of the specific application.

In some examples, pneumatic tools include internal components that are rotated at high speeds during use. These components can continue to rotate after the pneumatic air is no longer supplied. In one example, the components continue to rotate up to 90 seconds after the air supply is removed. During this time, the tool cannot be used for other applications, such as working on another workpiece. Further, this “spin-down” period may delay a worker from entering into the tool environment as the tool is required to come to a complete stop before the worker can enter the environment. This spin-down period can affect the efficiency of the tool and reduce the usefulness of the tool.

The Background section of this document is provided to place embodiments of the present invention in technological and operational context, to assist those of skill in the art in understanding their scope and utility. Approaches described in the Background section could be pursued but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

One aspect relates to a turbine motor comprising a housing with a receptacle, and a turbine blade rotatably positioned in the receptacle. The turbine blade comprises a central body and outwardly-extending arms. A channel extends through the housing and into the receptacle to deliver air to rotate the turbine blade within the housing. Exhaust ports are spaced away from the channel and extend through the housing and into the receptacle to exhaust the air from the receptacle after the air provides a force to rotate the turbine blade.

In another aspect, the housing comprises a floor that forms a side of the receptacle and a sidewall that extends around a perimeter of the floor and forms a lateral wall of the receptacle with the exhaust ports extending through the floor and the channel extending through the sidewall.

In another aspect, the exhaust ports are arranged along a rotational path of the turbine blade and are spaced radially outward away from a central section of the receptacle with the exhaust ports positioned in closer proximity to the sidewall than to a center of the receptacle.

In another aspect, the exhaust ports are arranged along a rotational path of the turbine blade and a first one of the exhaust ports in closest proximity to the channel is smaller than a last one of the exhaust ports.

In another aspect, the exhaust ports comprise a first set in closer rotational position to the channel and a second set, with the exhaust ports of the first set smaller than the exhaust ports of the second set.

In another aspect, the first set comprise first and second rows of the exhaust ports that extend through a floor of the receptacle with the first row aligned at a different radial position away from a center of the receptacle than the second row.

In another aspect, recesses are formed between adjacent ones of the arms of the turbine blade with the recesses comprising a curved shape formed by a trailing edge of a first one of the arms and a leading edge of an adjacent one of the arms.

In another aspect, each of the recesses comprises a width measured between the arms and a first one of the exhaust ports is located away from the channel a distance that is greater than the width.

In another aspect, a plug is mounted in a first one of the exhaust ports to prevent the air from escaping from the receptacle through the first exhaust port with the plug constructed from a different material than the housing.

One aspect is directed to a turbine motor comprising a housing with a receptacle, and a turbine blade rotatably positioned in the receptacle. The turbine blade comprises a central body an outwardly-extending arms that are spaced apart by recesses. A channel extends through the housing and into the receptacle to deliver air to the receptacle. Exhaust ports extend through the housing and into the receptacle to exhaust the air from the receptacle. The exhaust ports comprise a first set of exhaust ports and a second set with the second set of exhaust ports located a greater rotational distance away from the channel than the first set, and with the first set of exhaust ports being smaller than the second set of exhaust ports.

In another aspect, the first set of exhaust ports are arranged in rows that are aligned at different radial positions away from a center of the receptacle.

In another aspect, the first set of the exhaust ports is spaced away from the channel a greater distance than a length of the recesses measured between adjacent ones of the arms.

In another aspect, the housing comprises a floor and a sidewall that extend around and form the receptacle and with the channel aligned to introduce the air into the receptacle in a direction along the sidewall and away from the central body of the turbine blade.

In another aspect, the exhaust ports of the first set are smaller than the recesses and a portion of the air remains in the recesses.

One aspect is directed to a turbine motor comprising a housing comprising outer walls that extend around a receptacle, a channel that extends through the housing and into the receptacle to deliver air to the receptacle, a turbine blade positioned in the receptacle and which rotated within the receptacle when acted upon by the air that enters through the channel, and a brake mounted to the housing and that receives a portion of the air from the channel with the brake movable between an engaged position against the turbine blade to inhibit rotation of the turbine blade and a disengaged position away from the turbine blade. The brake is biased towards the engaged position and movable to the disengaged position when air is moving through the channel and into the receptacle to rotate the turbine blade.

In another aspect, the brake comprises a piston with a first section that contacts against the turbine blade in the engaged position, a biasing member that acts on the piston to bias the piston to the engaged position with the first section in contact with the turbine blade, and one or more seals that prevent the air from leaking.

In another aspect, a bore in the housing is sized to receive a piston that contacts against the turbine blade in the engaged position with the bore positioned in communication with the receptacle.

In another aspect, a conduit extends from the channel to deliver the air to the bore with the conduit extending from the channel at a point upstream from the receptacle.

In another aspect, the conduit comprises a first linear section that extends from the channel and a second linear section that extends between the first linear section of the bore with the first and second linear sections being perpendicular to each other and aligned in different planes.

One aspect is directed to a turbine motor comprising a housing comprising a receptacle, a bore, a channel that extends through the housing and comprises an inlet at an outer side of the housing and an inlet at the receptacle, and a conduit that extends from the channel and into the bore. A turbine blade is positioned in the receptacle. A brake is positioned in the housing and comprises a piston that is movable between an engaged position against the turbine blade to inhibit rotation of the turbine blade and a disengaged position away from the turbine blade. The piston is biased towards the engaged position and movable to the disengaged position when air flows through the channel and the conduit.

In another aspect, the brake comprises a piston that contacts against the turbine blade in the engaged position, a biasing member that acts on the piston to bias the piston to the engaged position in contact with the turbine blade, and one or more seals that prevent the air from leaking.

In another aspect, each of the channel and the conduit comprise multiple linear sections that extend through the housing.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a top perspective view of a turbine motor attached to a tool.

FIG. 2 is a bottom perspective view of the turbine motor of FIG. 1 attached to the tool.

FIG. 3 is a section view cut along line III-Ill of FIG. 1 illustrating a turbine blade positioned within a housing of the turbine motor with the turbine blade in a first rotational position.

FIG. 4 is a section view cut along line IV-IV of FIG. 5 illustrating a channel extending through the housing and into a receptacle.

FIG. 5 is a bottom view of a turbine motor.

FIG. 6 is a section view of the turbine blade of FIG. 3 in a second rotational position.

FIG. 7 is a section view of the turbine blade of FIG. 6 in a third rotational position.

FIG. 8 is a section view of the turbine blade with a plug mounted in one of the exhaust ports.

FIG. 9 is a section view cut along line IX-IX of FIG. 12 of a channel and a conduit that extend through a housing.

FIG. 10 is a section view cut along line X-X of FIG. 5 of a brake positioned in a bore of a housing.

FIG. 11 is a section view cut along line XI-XI of FIG. 12 of a brake positioned in a bore of a housing.

FIG. 12 is a perspective view of a turbine motor attached to a tool 100.

FIG. 13 is a schematic diagram of a turbine motor.

FIG. 14 is a schematic diagram of a turbine motor.

FIG. 15 is a schematic diagram of a turbine motor.

FIG. 16 is a schematic diagram of a turbine motor attached to a tool with air supplied from an air supply.

FIG. 17 is a schematic diagram of a turbine motor and tool attached to a robot.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

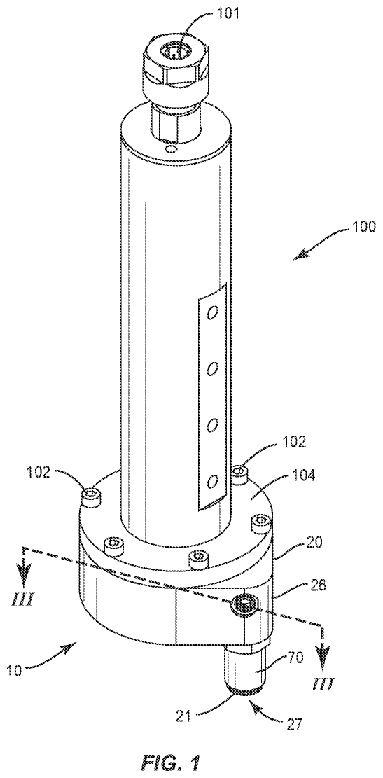

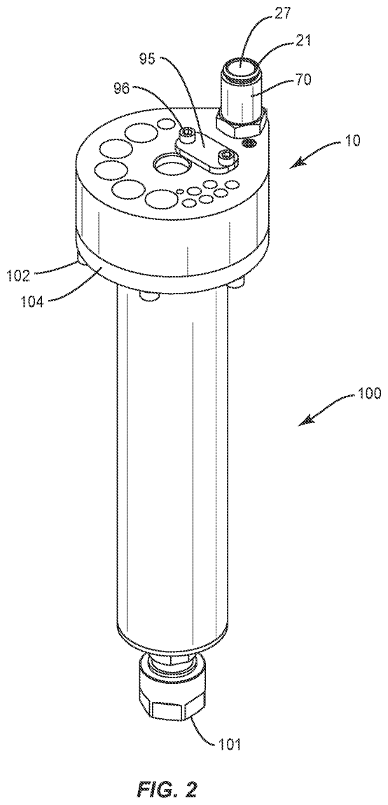

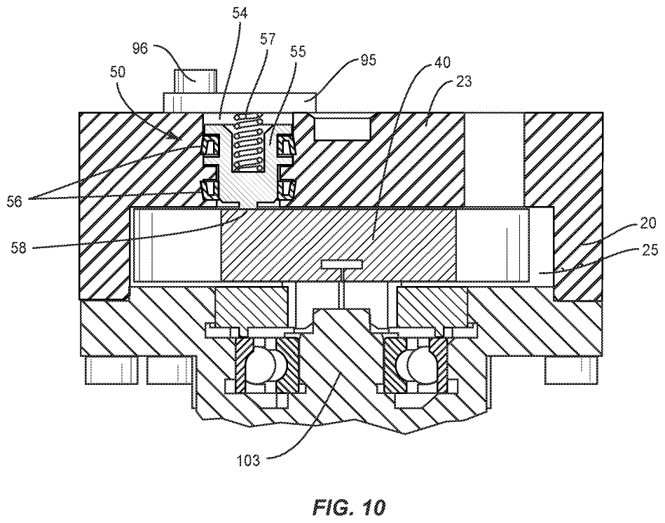

FIGS. 1 and 2 illustrate a turbine motor 10 connected to a tool 100, such as a spindle 100. The turbine motor 10 includes a channel 27 with an inlet 21 to receive air to pneumatically drive an interior turbine blade (not illustrated in FIGS. 1 and 2). The turbine blade is operatively connected to a shaft housing 103 (FIG. 10) which itself is connected to a shaft that extends within the tool spindle 100. The turbine motor 10 is configured to provide for one or more features that provide enhanced functionality. One feature includes a modular design that can be tailored to adjust the torque of the turbine blade and thus the output of the turbine motor 10. Another feature includes a brake that stops rotation of the turbine blade.

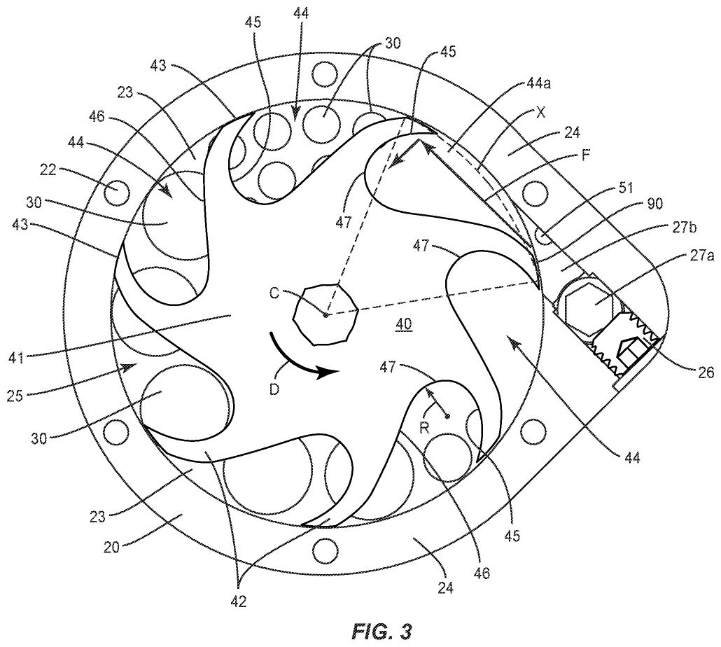

As illustrated in FIG. 3, the turbine motor 10 includes a housing 20 that includes a floor 23 and sidewall 24. The sidewall 24 extends outward around a perimeter of the floor 23. A receptacle 25 is formed by the floor 23 and sidewall 24 and is sized to receive the turbine blade 40. The inner sides of the floor 23 and sidewall 24 are smooth to allow for rotation of the turbine blade 40 within the receptacle 25. The receptacle 25 has a circular shape. When the turbine motor 10 is attached to the tool spindle 100, the receptacle 25 is enclosed within the housing 20 and a flange 104 of the spindle 100. The sidewall 24 includes an upper edge that abuts against the spindle 100. Cavities 22 in the sidewall 24 are configured to receive fasteners 102 to secure the housing 20 to the spindle 100.

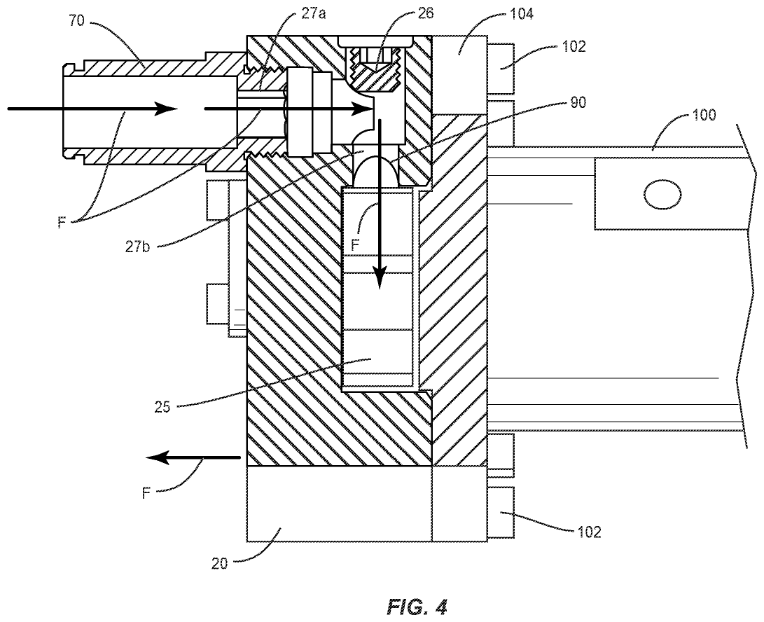

As illustrated in FIGS. 3 and 4, the channel 27 extends through the housing 20 and into the receptacle 25. In one example, a fitting 70 is connected to the housing 20 and extends outward from the inlet 21 to extend the channel 27 beyond the housing 20.

The channel 27 includes multiple sections aligned at non-parallel angles relative to each other. In one example as illustrated in FIG. 4, the channel 27 includes a first section 27a that extends inward from the outer side of the housing 20, and a second section 27b. In one example as illustrated in FIG. 4, the first and second sections 27a, 27b are perpendicular. The throttle member 26 is secured in the passage and is adjustable relative to the housing 20 to control the flow of air through the channel 27. The throttle member 26 can be adjusted to expand or constrict the channel 27. In one example, the throttle member 26 is threaded to the housing 20 and plugs the passage to prevent air from escaping. In another example, the throttle member 26 includes a flexible body that is inserted into the housing and forms a friction fit to secure the position. In another example, the throttle member 26 is fixedly attached to the housing 20 (i.e., the throttle member 26 is not able to be adjusted relative to the housing 20).

As illustrated in FIG. 3, the air moves into and along the receptacle as illustrated by arrows F. The air is delivered into the receptacle 25 along the sidewall 24 and away from a center C of the receptacle 25. The air contacts against the turbine blade 40 and provides a force to rotate the turbine blade 40 within the receptacle 25.

Exhaust ports 30 extend through the floor 23 of the housing 20 and are in communication with the receptacle 25. The exhaust ports 30 provide a path to exhaust the air out of the receptacle 25. The number, size, and position of the exhaust ports 30 can vary to control the airflow within the receptacle 25 and the amount of torque that the turbine blade 40 applied to the spindle 100.

The turbine motor 10 captures energy from the moving air. Kinetic energy of the moving air is captured and converted into mechanical energy. In one example, the turbine motor 10 is an impulse style turbine with the air directed onto the turbine blade 40 causing rotation which converts the kinetic energy of the air to rotate the turbine blade 40 and the attached shaft housing 103 (see FIG. 10). The impulse style turbine changes the flow direction of the air which transfers the kinetic energy of the air to the turbine blade 40.

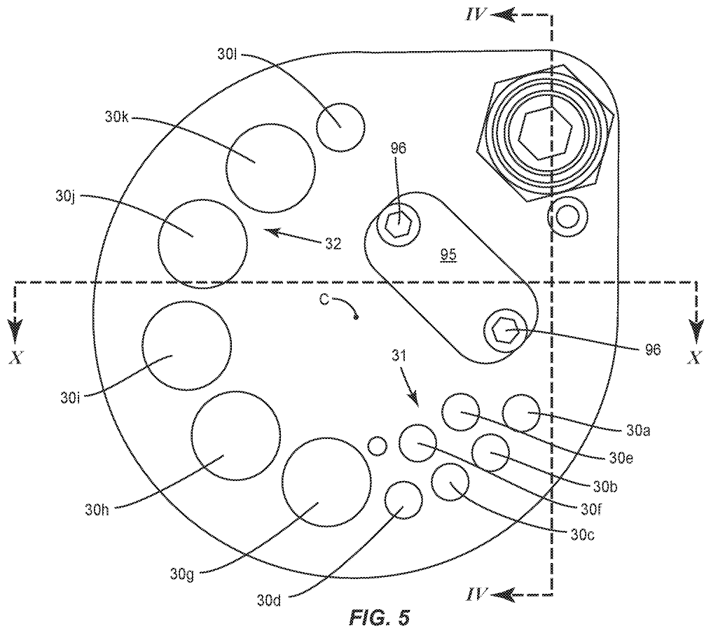

FIG. 5 illustrates exhaust ports 30 that extend through the floor 23 of the housing 20. The exhaust ports 30 are arranged along the radially outer section of the receptacle 25 in proximity to the sidewall 24 and away from the center C. The exhaust ports 30 are aligned along the rotational path that the arms 42 of the turbine motor 40 travel within the receptacle 25. As illustrated in FIG. 3, each of the exhaust ports 30 is positioned a distance away from the inlet 90 of the channel 27 into the receptacle 25 measured along the arc length X between a center of the channel 27 and a center of the exhaust port 30. In one example, the exhaust ports 30 are arranged along a rotational path of the turbine blade 40 and are spaced radially outward away from a center C of the receptacle 25 with the exhaust ports 30 positioned in closer proximity to the sidewall 24 than to the center C of the receptacle 25.

As illustrated in FIGS. 3 and 5, the exhaust ports 30 are arranged in an array across the floor 23 of the housing 20. The exhaust ports 30 can include a first set 31 located in closer proximity to the inlet 90 of the channel 27. The first set 31 includes exhaust ports 30 that are arranged at different radial positions relative to the center C of the of the receptacle 25. FIG. 5 includes a first outer row of exhaust ports 30a, 30b, 30c, 30d and a second inner row of exhaust ports 30e, 30f. In one example, the exhaust ports 30 in each row are spaced an equal distance from the center C. In another example, the exhaust ports 30 in each row are spaced different distances from the center C. In one example, each of the exhaust ports 30 in the first set 31 are the same shape and size. In another example, two or more of the exhaust ports 30 in the first set 31 include different shapes and/or sizes.

A second set 32 of exhaust ports 30 are spaced a greater rotational distance away from the inlet 90 of the channel 27. As illustrated in FIG. 5, the second set 32 includes exhaust ports 30g, 30h, 30i, 30j, 30k, and 30l. These exhaust ports 30 are spaced apart along the sidewall 24. In one example, the exhaust ports 30 of the second set 32 are each spaced an equal distance away from the center C. The exhaust ports 30 of the second set 32 can include the same or different shapes and/or sizes.

In one example, the exhaust ports 30 of the first set 31 are smaller than those of the second set 32. The difference is size is because the first set 31 is used to control the amount of force applied by the air to the turbine blade 40. The second set 32 exhausts the air from the receptacle 25 after the work has been performed. In one example, the exhaust port 30a closest to the channel 27 is smaller than exhaust port 30l that is farthest from the channel 27.

The turbine blade 40 is positioned in the receptacle 25. The turbine blade 40 rotates in the direction of arrow D when acted upon by the air entering through the channel 27. The turbine blade 40 is centered at the center C of the receptacle 25. The turbine blade 40 is operatively connected to a shaft housing 103 (FIG. 10) that extends through the spindle 100 and provides for rotating a tool mounted in the receptacle 101 at the end of the shaft housing 103.

The turbine blade 40 includes a thickness measured between upper and lower surfaces. The turbine blade 40 is scalable to adjust a thickness to thereby adjust the torque. A thinner blade is configured to rotate faster but produces less torque. A thicker blade is configured to rotate slower but will produce more torque.

As illustrated in FIG. 3, the turbine blade 40 includes a central body 41 and outwardly-extending arms 42. The turbine blade 40 is centered in the receptacle 25 (i.e., a center of the turbine blade 40 is positioned at the center C of the receptacle 25). Each of the arms 42 includes an outer edge 43 that faces towards the sidewall 24 of the housing 20. In one example, the outer edge 43 is flat. In another example, the curvature of the edge 43 matches the curvature of the sidewall 24. The diameter of the turbine blade 40 corresponds to the diameter of the receptacle 25 to provide for rotation of the turbine blade 40 and prevent and/or reduce air flow between the outer edges 43 of the arms 42 and the sidewall 24. In one example, a nominal gap is formed between the outer edges 43 of the arms 42 and the sidewall 24. In one specific example, the nominal gap is 0.012 inches.

The number of arms 42 on the turbine blade 40 can vary. In one example as illustrated in FIG. 3, the turbine blade 40 includes seven arms. Other examples can include different numbers. The arms 42 are spaced apart at even intervals around the perimeter of the central body 41. Further each of the arms 42 includes the same shape and size to provide for even rotation of the turbine blade 40 without causing excessive vibrations.

A recess 44 is formed between each of the adjacent arms 42. The recess 44 has a curved shape that is formed by a trailing edge 45 of a first arm 42 and a leading edge 46 of an adjacent second arm 42. A bottom section 47 of the recess 44 has a radius R. The radius R can be uniform or non-uniform. The curved shape of the recess 44 directs the movement of air that is introduced through the channel 27 as will be explained in detail below.

The size and shape of the recess 44 relative to the positioning of the exhaust ports 30 provides for moving the air within the receptacle 25 and driving the turbine blade 40. As illustrated by the air flow F in FIG. 3, air entering through the channel 27 is directed into the one or more recesses 44 that are aligned with the channel 27. In at least one of the recesses 44, the air is directed from the channel 27 substantially along the sidewall 24 and against the curved edge 45 of the recess 44. The air impacts against the edge 45 and drives the turbine blade 40 to rotate in the direction D. The curvature of the edge 45 then directs the air towards the bottom of the recess 44. This air movement discourages the air from leaking out along the edge 43 which would increase friction between the turbine blade 40 and the sidewall 24. This also allows for more torque to transfer because the air pushes against the edge 45 rather than being directed away from the edge.

In one example, the initial position when air is input from the channel 27 into the recess 44 includes that none of the exhaust ports 30 are exposed in the recess 44. This provides for the air to work against the turbine blade 40 and provide a rotational force prior to being exhausted from the receptacle 25. In one example, a width of the recesses 44 measured between the adjacent arms 42 is greater than a distance between the inlet 90 of the channel 27 and the first exhaust port 30.

In another example, one or more exhaust ports 30 are exposed in the recess 44 when the recess 44 is aligned with the channel 27. The one or more initial exhaust ports 30 are positioned for the air to initially strike against the leading edge 45 and rotate the turbine blade 40 prior to being exhausted from the receptacle 25. The exhaust of air concurrently with the introduction of air into the recess 44 can prevent air turbulence and direct air out of the recess 44 instead of against the edge 45 which can decrease the efficiency of the rotation.

The exhaust ports 30a-30e in the first set 31 are configured to control the force that is applied to the turbine blade 40. As illustrated in FIG. 3, the air from the channel 27 enters into the recess 44a along the sidewall 24. The air contacts against the edge 45 of the arm 42 and is directed along the edge 45 towards a bottom section 47 of the recess 44a. In one example as illustrated in FIG. 3, the air is introduced from the channel 27 and contacts against the turbine blade 40 prior to contact against the sidewall 24.

The force of the air contacting against the turbine blade 40 rotates the turbine blade 40 within the receptacle 25. FIG. 6 illustrates the turbine blade 40 at a subsequent rotational position beyond that of FIG. 3. At this subsequent rotational position, the recess 44a has moved farther within the receptacle 25 and is no longer receiving air from the channel 27. The exhaust ports 30a, 30e are exposed in the recess 44a. The airflow F in the recess 44a is along the sidewall 24 and then directed radially inward by the leading edge 45. The air is then encouraged to be rotated within the recess 44a as it moves away from the bottom of the leading edge 45 and radially outward. As further illustrated in FIG. 6, recess 44b rotates into alignment with the channel 27. The air moves into the recess 44b and strikes against the edge 45 to repeat the process described above for recess 44a.

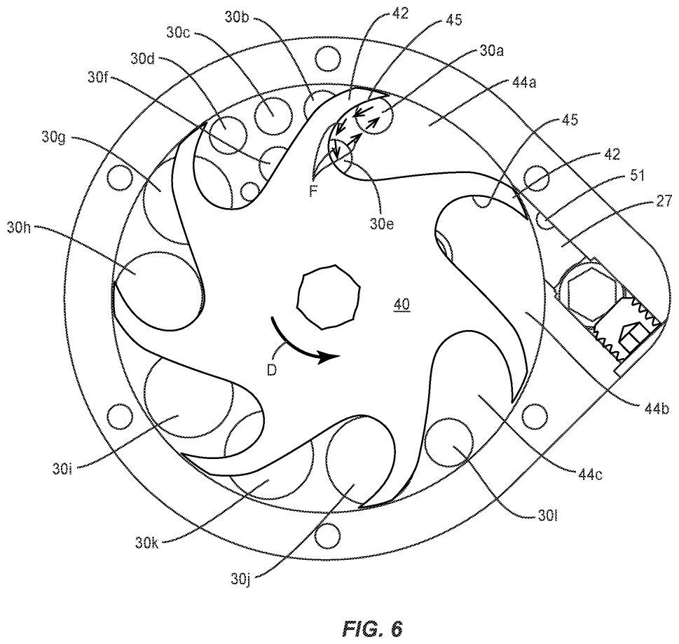

The second set 32 of exhaust ports 30g-30l are positioned downstream from the first set 31 relative to their rotational position of the turbine blade 40. These exhaust ports 30g-30l function to remove the air because there is little reason for the air to remain in the recess 44 after the air has done work on the turbine blade 40. Removing the air from the recesses 44 provides for the turbine blade 40 to rotate more freely as the remaining air can act as a dampener to restrict rotation. Additionally or alternatively, the air remaining in the recesses 44 can cause negative torque on the turbine blade 40 to affect the rotation. In one example as illustrated in FIG. 7, the exhaust ports 30g-30l of the second set 32 include a greater size than the exhaust ports 30a-30f of the first set 31. In one example as illustrated in FIG. 7, one or more of the exhaust ports 30g-30l are sized to extend across the entirety of a bottom section 47 of the recess 44. This sizing provides for the air in the recess 44 to readily evacuate.

Exhaust port 30l is the last of the second set 32. It is the exhaust port 30 that is the farthest away from the channel 27. In one example, the exhaust port 30l is smaller than the other exhaust ports 30g-30k. This exhaust port 30l is positioned and sized to prevent the air from contacting against the trailing edge 46 of the arm 42 which could cause negative torque on the turbine blade 40. This smaller size and/or positioning prevents the exhaust port 30l from being exposed within a recess 44 that is concurrently receiving air from the channel 27. If the exhaust port 30l was larger enough and/or positioned to be exposed within a recess 44 that is receiving air, the air would be influenced to exit through the exhaust port 30l which would cause negative torque on the turbine blade 40.

In one example, the housing 20 includes a predetermined number of exhaust ports 30. Each of the exhaust ports 30 are used to exhaust the air during operation of the turbine motor 10. The exhaust ports 30 are positioned and sized to manipulate the performance of the turbine blade 40 to provide the required output for the turbine motor 10.

In another example, one or more of the exhaust ports 30 can be closed with plugs 80. Plugs 80 are configured to be inserted into an exhaust port 30 and prevent air flow through the exhaust port 30. One or more of the exhaust ports 30 can be plugged to control and adjust the performance of the turbine blade 40 as needed. The plugs 80 can include various configurations, including but not limited to screws, rivets, and friction fit configurations that prevent the air from escaping through the exhaust port 30. Plugs 80 can be used to close one or more of the exhaust ports 30 of the first set 31, second set 32, or both.

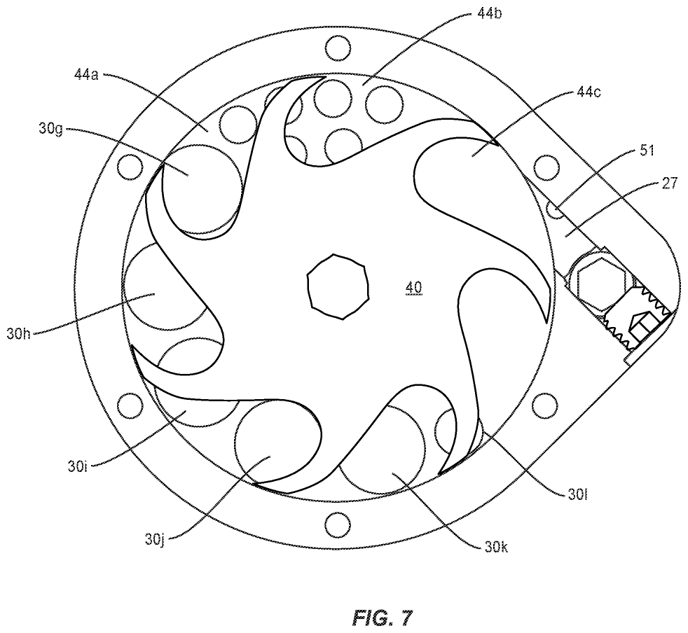

FIG. 8 illustrates an example in which exhaust port 30a is closed with plug 80. The remaining exhaust ports 30b-30l remain open. The air that has been introduced through the channel 27 moves along the sidewall 24 and is directed radially inward by the edge 45 as indicated by arrows F. The air follows along the leading edge 45 and turns around the curve of the bottom section 47 thus increasing the momentum transferred. Providing a meaningful path for the air by inserting one or more plugs 80 in the exhaust ports 30 discourages turbulent flow and provides for a different operational setting for the turbine motor 10.

In one example, the exhaust ports 30 extend through the floor 23 of the housing 20 and exhaust the air to the exterior of the housing 20 (see FIG. 4). In another example, one or more of the exhaust ports 30 extend through the sidewall 24. These exhaust ports 30 function in the same manner to exhaust the air from the receptacle 25 to the exterior of the housing 20.

Additionally or alternatively, the turbine motor 10 includes a brake 50 to slow and/or stop the rotation of the turbine blade 40 in the receptacle 25. In one example, the brake 50 is used in combination with the exhaust ports 30 described above. In another example, the brake 50 is used independently (i.e., in a design without the exhaust ports 30 described above). The brake 50 is controlled by air that enters the housing 20 through the channel 27.

The brake 50 is forced by a biasing member 57 to engage with the turbine blade 40 when air is not entering into the channel 27. The force applied by the biasing member 57 is overcome and the brake 50 is disengaged when air enters into the channel 27. This disengaged position provides for the turbine blade 40 to rotate unhindered by the brake 50. The brake 50 is further configured to be applied to the turbine blade 40 when air is not entering into the channel 27. When the air is stopped, the brake 50 engages with the turbine blade 40 to slow and/or stop the rotation.

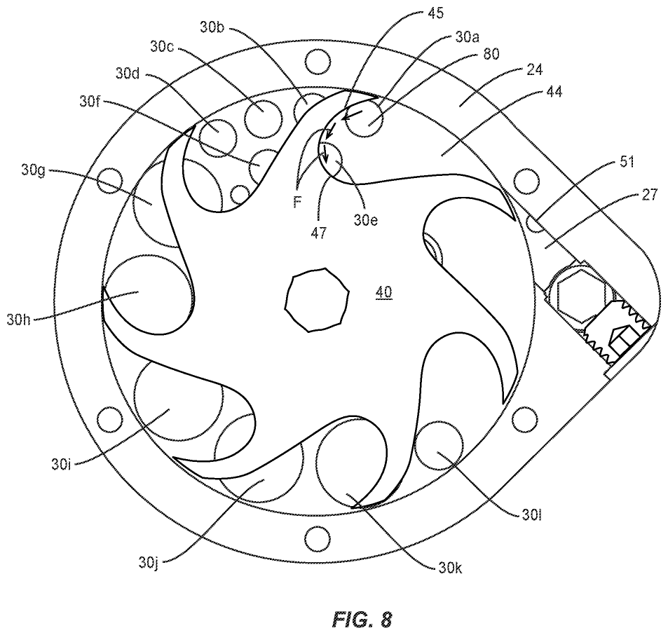

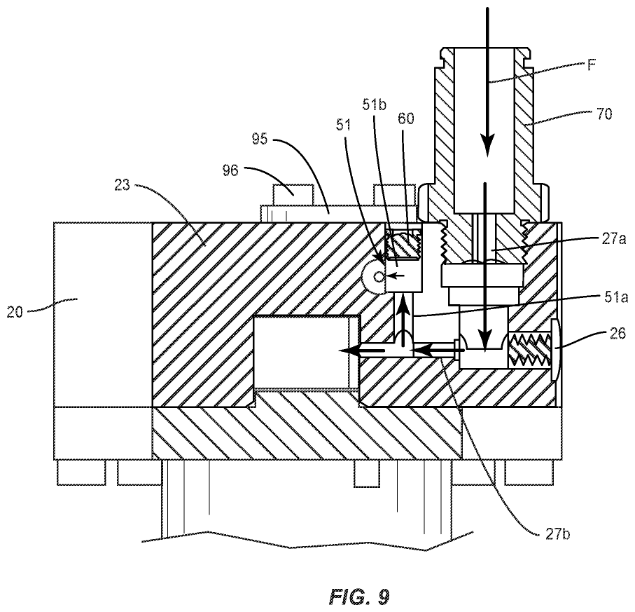

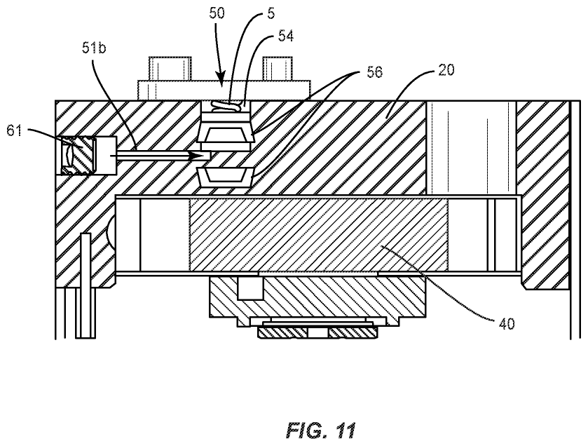

FIGS. 9, 10, and 11 illustrated aspects of the brake 50 including the air flow into the housing 20. The brake 50 is positioned in a bore 54 formed in the housing 20. The bore 54 is in communication with the receptacle 25 to provide for the brake 50 to contact against the turbine blade 40.

Air is supplied to the brake 50 through a conduit 51 that extends from the channel 27. The remainder of the air that is not diverted into the conduit 51 is directed through the channel 27 and into the receptacle 25 to drive the turbine blade 40. The conduit 51 includes a first section 51a and a second section 51b. The first section 51a extends from the channel 27. In one example as illustrated in FIG. 9, the first section 51a extends from the second section 27b of the channel 27. The second section 51b extends between the first section 51a and the bore 54.

The brake 50 is positioned in the bore 54 and configured to move between the engaged and disengaged positions. The brake 50 includes a pair of seals 56 that are spaced apart within the bore 54. The seals 56 can include various configurations, including but not limited to molded U-cups and o-rings. The second section 51b of the conduit 51 enters into the bore 54 between the pair of seals 56. A piston 55 is positioned in the bore 54. In one example, one of the seals 56 is fixed in position relative to the housing 20 and the other seal 56 moves with the piston 55. In another example, both seals 56 move with the piston 55. In another example, both seals 56 are fixed. The piston 55 is positioned in the bore 54 with a first end 58 facing towards the turbine blade 40. A biasing member 57, such as a spring or elastic material, biases the piston 55 towards the turbine blade 40.

Air entering through the conduit 51 enters the bore 54 between the seals 56. The force of the air overcomes the force applied by the biasing member 57. The air forces the piston 55 away from the turbine blade 40 and positions the piston 55 in the disengaged position with the first end 58 spaced away from the turbine blade 40.

When the air is stopped, such as when the turbine motor 10 is not in use, the force applied by the biasing member 57 moves the piston 55 to the engaged position. The first end 58 of the piston 55 contacts against the turbine blade 40 and slows and/or stops the rotation of the turbine blade 40 in the receptacle 25.

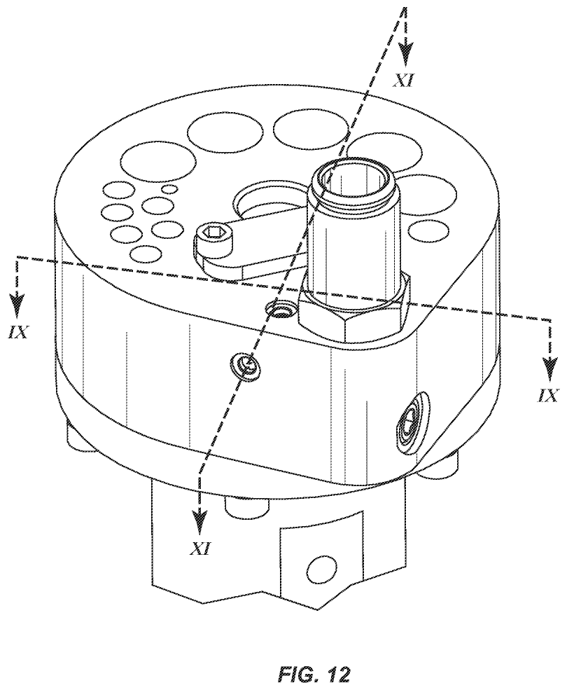

The channel 27 and conduit 51 are configured to accommodate manufacturing. The channel 27 includes the first and second sections 27a, 27b, and the conduit 51 includes the first and second sections 51a, 51b. As illustrated in FIGS. 9, 11, and 12, the first section 27a and second section 27b of the channel 27 are perpendicular to each other. The first section 27a is machined into the housing 20 through the floor 23. The second section 27b is machined through the sidewall 24 at opening 28. The throttle member 26 is placed across the second section 27b at the opening 28. The throttle member 26 can be adjusted within the housing 20 to control a size of the channel 27 and the amount of air that reaches the turbine blade 40 and brake 50.

For the conduit 51, the first section 51a is formed through the floor 23 and includes a plug 60. The second section 51b is formed through an opening in the sidewall 24 and includes a plug 61. The first section 51a intersects the second section 27b of the channel 27. In one example, the first section 51a is perpendicular to the second section 27b, and the second section 51b is perpendicular to the first section 51a. In one example, the axes of the first and second sections 51a, 51b are perpendicular but not co-planar. In another example, the first and second sections 51a, 51b are co-planar. The positioning of the sections 27a, 27b, 51, 51b provides for the housing 20 to be machined and for each of the sections to be formed through the exterior of the housing 20. In another example, one or more of the channel 27 and the conduit include a single section. In one specific example, the single section is straight.

The various plugs 29, 60, 61 can be attached to the housing 20 in various manners. Functionally, the plugs close the openings in the housing 20 and prevent air from escaping. The plugs further provide for keeping the sections pressurized. One or more of the plugs 29, 60, 61 can be adjusted within the housing 20 to control a size of the channel/conduit and control the amount of air. The plugs 29, 60, 61 can have a variety of constructions and be attached to the housing 20 in various manners. Examples include threaded attachment and friction fit. In one example, the plugs are constructed of a different material than the housing 20. In another example, the plugs are constructed from the same material.

The bore 54 is formed through the floor 23 of the housing 20. A plate 95 extends across the opening in the floor 23 that forms the bore 54. One of more fasteners 96 extend through the plate 95 and into the housing 20 to maintain the attachment. The position of the bore 54 within the housing 20 at the floor 23 facilitates manufacturing of the turbine motor 10.

In one example as disclosed above, the turbine motor 10 includes a single channel 27 that feeds airs into the receptacle 25. In other examples, two or more channels 27 extend through the receptacle 25 to introduce air into the receptacle 25. In one example, the turbine motor 10 includes a single turbine blade 40. Other examples include a turbine motor 10 with two or more turbine blades 40. The multiple turbine blades 40 can be powered by air that is input through a single channel 27, or through multiple channels 27.

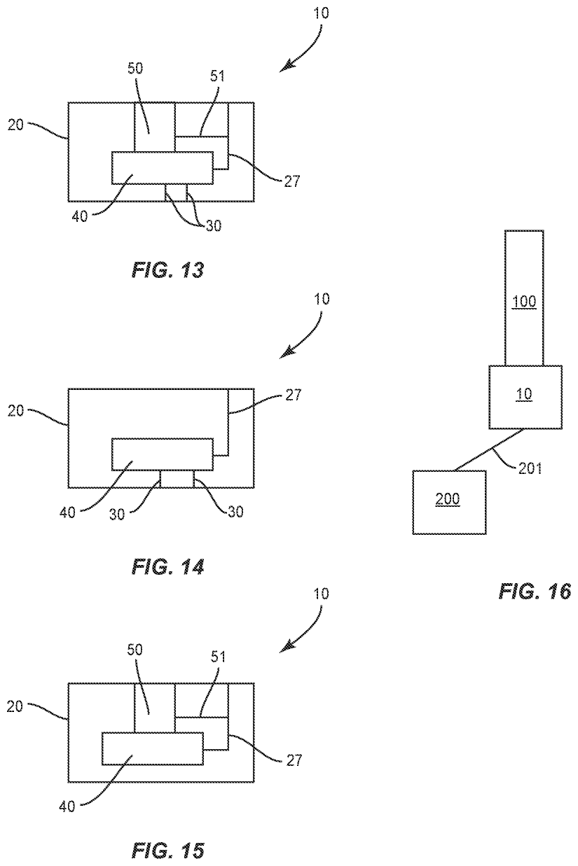

The turbine motor 10 can include a variety of different configurations depending upon the context of use. FIG. 13 schematically illustrates a turbine motor 10 that includes a turbine blade 40 with exhaust ports 30, and a brake 50. FIG. 14 schematically illustrates a turbine motor 10 that includes a turbine blade 40 with exhaust ports 30. FIG. 15 schematically illustrates a turbine motor 10 with a turbine blade 40 and a brake 50.

The turbine motor 10 can be used in a variety of different contexts. In one example as schematically illustrated in FIG. 16, the turbine motor 10 is used with a hand-held tool. The turbine motor 10 is connected to shaft of a tool 100. The tool 100 and turbine motor 10 are handled and operated by an operator. The turbine motor 10 is operatively connected to an air source 200 that includes a pressurized air line 201 to supply the air.

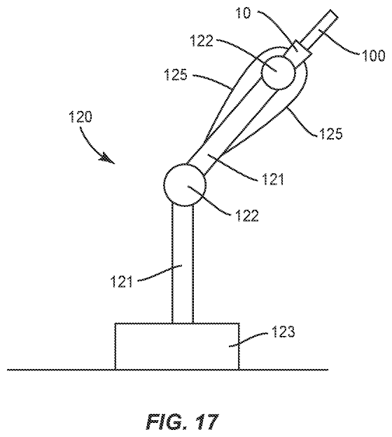

In another example as illustrated in FIG. 17, the turbine motor 10 is configured to be connected to and operated by a robot 120. The turbine motor 10 can be used with a wide variety of robots 120 that provide for attachment, movement, and operation. The robots 120 can provide a variety of different movements and positions for the turbine motor 10 and attached tool 100 to perform the specific tasks. The robot 120 can include one or more arms 121 that are movably connected together at joints 122. The robot 120 can also include a base 123 that can be fixed to a support floor or can be movable about the support floor. One or more utility lines 125 extend from the robot 120 and into the turbine motor 10 to supply one air to power the turbine motor 10. One or more of the utility lines 125 can also be attached to the tool 100, either directly or through the turbine motor 10. FIG. 17 schematically illustrates a pair of utility lines 125 positioned on the exterior of the outer-most arm 121 and connected to the turbine motor 10. Another example includes the utility lines 125 being separate from the robot 120.

As used herein, the term “configured to” means set up, organized, adapted, or arranged to operate in a particular way; the term is synonymous with “designed to.”

The present invention may be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A turbine motor comprising:
a housing with a receptacle;
a turbine blade rotatably positioned in the receptacle, the turbine blade comprising a central body and outwardly-extending arms;
a channel that extends through the housing and into the receptacle to deliver air to rotate the turbine blade within the housing; and
exhaust ports that are spaced away from the channel and that extend through the housing and into the receptacle to exhaust the air from the receptacle after the air provides a force to rotate the turbine blade.

2. The turbine motor of claim 1, wherein the housing comprises a floor that forms a side of the receptacle and a sidewall that extends around a perimeter of the floor and forms a lateral wall of the receptacle with the exhaust ports extending through the floor and the channel extending through the sidewall.

3. The turbine motor of claim 2, wherein the exhaust ports are arranged along a rotational path of the turbine blade and are spaced radially outward away from a central section of the receptacle with the exhaust ports positioned in closer proximity to the sidewall than to a center of the receptacle.

4. The turbine motor of claim 1, wherein the exhaust ports are arranged along a rotational path of the turbine blade and a first one of the exhaust ports in closest proximity to the channel is smaller than a last one of the exhaust ports.

5. The turbine motor of claim 4, wherein the exhaust ports comprise a first set in closer rotational position to the channel and a second set, with the exhaust ports of the first set smaller than the exhaust ports of the second set.

6. The turbine motor of claim 5, wherein the first set comprise first and second rows of the exhaust ports that extend through a floor of the receptacle with the first row aligned at a different radial position away from a center of the receptacle than the second row.

7. The turbine motor of claim 1, further comprising recesses formed between adjacent ones of the arms of the turbine blade, the recesses comprising a curved shape formed by a trailing edge of a first one of the arms and a leading edge of an adjacent one of the arms.

8. The turbine motor of claim 7, wherein each of the recesses comprises a width measured between the arms and a first one of the exhaust ports is located away from the channel a distance that is greater than the width.

9. The turbine motor of claim 1, further comprising a plug mounted in a first one of the exhaust ports to prevent the air from escaping from the receptacle through the first exhaust port, the plug constructed from a different material than the housing.

10. A turbine motor comprising:
a housing with a receptacle;
a turbine blade rotatably positioned in the receptacle, the turbine blade comprising a central body an outwardly-extending arms that are spaced apart by recesses;
a channel that extends through the housing and into the receptacle to deliver air to the receptacle; and
exhaust ports that extend through the housing and into the receptacle to exhaust the air from the receptacle, the exhaust ports comprising a first set of exhaust ports and a second set with the second set of exhaust ports located a greater rotational distance away from the channel than the first set, and with the first set of exhaust ports being smaller than the second set of exhaust ports.

11. The turbine motor of claim 10, wherein the first set of exhaust ports are arranged in rows that are aligned at different radial positions away from a center of the receptacle.

12. The turbine motor of claim 10, wherein the first set of the exhaust ports is spaced away from the channel a greater distance than a length of the recesses measured between adjacent ones of the arms.

13. The turbine motor of claim 10, wherein the housing comprises a floor and a sidewall that extend around and form the receptacle and with the channel aligned to introduce the air into the receptacle in a direction along the sidewall and away from the central body of the turbine blade.

14. The turbine motor of claim 10, wherein the exhaust ports of the first set are smaller than the recesses and a portion of the air remains in the recesses.

15. A turbine motor comprising:
a housing comprising outer walls that extend around a receptacle;
a channel that extends through the housing and into the receptacle to deliver air to the receptacle;
a turbine blade positioned in the receptacle and which rotated within the receptacle when acted upon by the air that enters through the channel;
a brake mounted to the housing and that receives a portion of the air from the channel, the brake movable between an engaged position against the turbine blade to inhibit rotation of the turbine blade and a disengaged position away from the turbine blade; and
the brake biased towards the engaged position and movable to the disengaged position when air is moving through the channel and into the receptacle to rotate the turbine blade.

16. The turbine motor of claim 15, wherein the brake comprises:
a piston with a first section that contacts against the turbine blade in the engaged position;
a biasing member that acts on the piston to bias the piston to the engaged position with the first section in contact with the turbine blade; and
one or more seals that prevent the air from leaking.

17. The turbine motor of claim 15, further comprising a bore in the housing that is sized to receive a piston that contacts against the turbine blade in the engaged position, the bore positioned in communication with the receptacle.

18. The turbine motor of claim 17, further comprising a conduit that extends from the channel to deliver the air to the bore, the conduit extending from the channel at a point upstream from the receptacle.

19. The turbine motor of claim 18, wherein the conduit comprises a first linear section that extends from the channel and a second linear section that extends between the first linear section of the bore, the first and second linear sections being perpendicular to each other and aligned in different planes.

20. A turbine motor comprising:
a housing comprising:
a receptacle;
a bore;
a channel that extends through the housing and comprises an inlet at an outer side of the housing and an inlet at the receptacle;
a conduit that extends from the channel and into the bore;
a turbine blade positioned in the receptacle;
a brake positioned in the housing and comprising a piston that is movable between an engaged position against the turbine blade to inhibit rotation of the turbine blade and a disengaged position away from the turbine blade;
the piston biased towards the engaged position and movable to the disengaged position when air flows through the channel and the conduit.

21. The turbine blade of claim 20, wherein the brake comprises:
a piston that contacts against the turbine blade in the engaged position;
a biasing member that acts on the piston to bias the piston to the engaged position in contact with the turbine blade; and
one or more seals that prevent the air from leaking.

22. The turbine blade of claim 20, wherein each of the channel and the conduit comprise multiple linear sections that extend through the housing.
